(19) United States
(12) Patent Application Publication
(10) Pub. No.: US 2022/0379410 A1
(43) Pub. Date: Dec. 1, 2022

(54) ULTRASONIC WELDING DEVICE WITH INTEGRATED CAMERA ASSEMBLY

(71) Applicant: SCHUNK SONOSYSTEMS GMBH, Wettenberg (DE)

(72) Inventors: Stefan MÜLLER, Wetzlar (DE); Rainer WAGENBACH, Merenberg (DE); Waldemar WERNER, Reiskirchen (DE); Daniel GÜNTHER, Langgöns (DE); Dariusz KOSECKI, Biebertal (DE); Stephan BECKER, Marburg (DE); Eugen KOCH, Grünberg (DE); Bernd HÄNISCH, Rendsburg (DE)

(73) Assignee: SCHUNK SONOSYSTEMS GMBH, Wettenberg (DE)

(21) Appl. No.: 17/773,677

(22) PCT Filed: Nov. 5, 2019
(86) PCT No.: PCT/EP2019/080249

§ 371 Date: May 2, 2022

(51) Int. Cl. B23K 31/12; H04N 5/225; H04N 5/247

(52) U.S. Cl. CPC B23K 31/12; H04N 5/2257; H04N 5/2256; H04N 5/247

(57) ABSTRACT

An ultrasonic welding device includes a sonotrode, an anvil, a receiving chamber in which joining partners to be welded are to be received and which is defined on opposing sides by the sonotrode on the one hand and by the anvil on the other hand, and a camera assembly with at least one camera which is integrated in the ultrasonic welding device. The camera assembly is configured to record images of at least one partial region of the receiving chamber for the optical monitoring of welding conditions which have an impact on welds of the joining partners.

### FIELD

The present invention relates to an ultrasonic welding device.

### BACKGROUND

For a wide variety of technical applications, it may be necessary to join two components together in a mechanically secure and/or electrically conductive manner For example, it may be necessary for various purposes to join cables or their strands together mechanically and in an electrically conductive manner This may be used, for example, to produce wiring harnesses or cable looms with the aid of which electrical consumers, inside a vehicle for example, may be electrically connected to each other, to an energy source and/or to a control system.

So-called ultrasonic welding was developed to produce substance-to-substance bonds between two electrically conductive components, providing them with high strength and good electrical conductivity. It is a special form of friction welding in which components to be welded, also referred to as joining partners or weld metal, are brought into surface contact with one another and moved against each other under low pressure and high-frequency mechanical vibrations. In this case, the vibrations may be generated with the aid of a sonotrode in which ultrasonic vibrations with frequencies of typically 20 kHz to 50 kHz are generated and transmitted to at least one of the joining partners. Plastic flow then allows the joining partners to permeate or interlock with each other close to the surface without the materials of the joining partners necessarily melting. Ultrasonic welding may therefore be used to bond joining partners together with low impact, quickly and economically.

Ultrasonic welding may in particular also be used for welding metal joining partners, such as strands of two or more cables that are to be joined, for example, or such as two or more individual wires of a strand of a cable to be welded together, for example. For this purpose, the joining partners are generally inserted into a receiving chamber of an ultrasonic welding device. The receiving chamber is a volume within the ultrasonic welding device which is surrounded by various components, such as, for example, a sonotrode, an anvil, a lateral slide, a touching element or the like, from two sides or even from four sides in a frame-like manner such that joining partners received therein may be positioned during a welding process and if possible are unable to escape from the receiving chamber at the sides. The joining partners received in the receiving chamber are then welded together between the ultrasonically vibrating sonotrode and the anvil.

In ultrasonic welding, various conditions, which are referred to herein as welding conditions below, may have an impact on the welds of joining partners produced by an ultrasonic welding process. For example, the positioning of the joining partners relative to each other and also the positioning of the joining partners within the receiving chamber during an ultrasonic welding process may have a significant impact on the quality of the weld produced. In particular, the ends of strands to be welded as joining partners should be positioned on top of each other as accurately as possible in the receiving chamber of the ultrasonic welding device so that they are received approximately in alignment with each other between the sonotrode and the anvil and can be welded together. In addition, insertion errors, in which joining partners are inserted in an unfavorable position within the receiving chamber or incorrect joining partners are even inserted, may have a negative impact on the weld produced, or on the product produced thereby. Furthermore, contamination on the tools used for welding, in particular on the sonotrode and/or the anvil, or contamination on the joining partners to be welded may have a negative impact on the weld produced. Furthermore, the tools of ultrasonic welding devices are typically subject to wear, so that they must be replaced from time to time. In this case, errors may occur and unsuitable tools may be inserted into an ultrasonic welding device, as a result of which the welds produced therewith may again be defective.

Traditionally, an operator of an ultrasonic welding device often had to ensure that the welding conditions in the ultrasonic welding device and the joining partners met particular specifications. For example, the operator had to correctly position cables to be welded with their strands inside the receiving chamber of the ultrasonic welding device. For this purpose, the operator had to regularly undergo special training and always operate the ultrasonic welding device with great concentration. In particular, it was in most cases necessary for the operator, for example after inserting the joining partners into the receiving chamber, to check the correct positioning thereof, for example by visual inspection, before the welding process was initiated. The operator could be assisted in these tasks by fixed stops provided in the ultrasonic welding device, positioning aids, such as, for example, markings provided on the sonotrode, and the like.

Furthermore, an operator's tasks could also include recognizing defective welds after a welding process had been performed. Welding defects could manifest themselves, for example, as loop formation, protruding wires, damage, shifts in the position of cables and/or other welding results deviating from a specification.

### SUMMARY

There may be a requirement for an ultrasonic welding device for welding at least two joining partners which is simple to operate, which assists with the monitoring of welding conditions and/or which permits a high quality of welded joints produced which is preferably consistent over a large number of welding operations.

Such a requirement may be met by the subject matter of the independent claim. Advantageous embodiments are defined in the dependent claims and the following description.

According to one aspect of the present invention, an ultrasonic welding device is described, which comprises a sonotrode, an anvil, a receiving chamber in which joining partners to be welded are to be received and which is defined on opposing sides by the sonotrode on the one hand and by the anvil on the other hand, and a camera assembly with at least one camera which is integrated in the ultrasonic welding device. The camera assembly is configured to record images of at least a partial region of the receiving chamber for the optical monitoring of welding conditions which have an impact on welds of the joining partners.

Without limiting the scope of the invention in any way, ideas and possible features relating to embodiments of the invention may be considered to be based, inter alia, on the thoughts and findings described below.

The joining partners to be welded are to be received in the receiving chamber of the ultrasonic welding device before and during the welding process. The receiving chamber is typically defined at least from two sides, often even from four sides, such that the joining partners can only be accommodated in a limited receiving volume. On two opposing sides, i.e. on the top and bottom for example, the receiving chamber may be defined on the one hand by a surface of the sonotrode and on the other hand by a surface of the anvil. The sonotrode and/or the anvil may be displaceable such that these two components can be moved in relation to each other, toward or away from each other, and in this way the receiving chamber can be made smaller or larger in a first direction, i.e. in the vertical direction for example. On two further opposing sides, which extend transverse, preferably perpendicular, to the previously mentioned two sides, i.e. on the left and right for example, the receiving chamber may additionally be defined on the one hand by a surface of a touching element and on the other hand by a surface of a lateral slide. The touching element and/or the lateral slide may again be displaceable such that these two components can be moved in relation to each other, toward or away from each other, and in this way the receiving chamber can be made smaller or larger in a second direction extending perpendicular to the above-mentioned first direction. In this case, the surfaces of said components may surround the receiving chamber like a frame, in particular a quadrangular frame. On the fifth or sixth side which is not defined by said components, the joining partners may be inserted or pushed in an insertion direction into the receiving chamber surrounded in a frame-like manner

The formulation “defining the receiving chamber on one side” may be understood to the effect that the respective surface of the component mentioned in each case results in the joining partners being unable to move beyond the boundary produced by this surface. For this purpose, the respective surface may completely cover the receiving chamber on the respective side. Alternatively, however, only partial covering of the receiving chamber on the respective side may also be sufficient, as long as it remains ensured that the joining partners are held within the receiving chamber.

The welding conditions to be complied with where possible during ultrasonic welding include, inter alia, that the joining partners are correctly positioned in the receiving chamber relative to each other and in an advantageous position in relation to the sonotrode and the anvil before the welding process is initiated. Since the receiving chamber of the ultrasonic welding device is relatively small and often difficult to see into, complying with the welding conditions may be challenging.

Hitherto, skill on the part of the operator of the ultrasonic welding device and visual monitoring by this operator were in most cases required for this purpose. Depending on the competence of the operator and/or their concentration, this could lead to fluctuations in the quality of the welded products produced.

In particular to assist the operator with the monitoring of welding conditions, it is proposed additionally to equip the ultrasonic welding device with a camera assembly.

The camera assembly is to comprise at least one camera. This camera, together with other components of the camera assembly, is to be integrated in the ultrasonic welding device, i.e. be part of the ultrasonic welding device. For this purpose, the camera assembly may, for example, be fixedly mounted on other components of the ultrasonic welding device. In addition, the camera assembly may interact functionally with other components of the ultrasonic welding device. For example, the camera may be supplied with electrical energy by an electrical energy supply which also supplies other components of the ultrasonic welding device. In addition, the camera may possibly forward data it generates to other components of the ultrasonic welding device such as, for example, a control system of the ultrasonic welding device.

The camera assembly is to be configured to record images of at least a partial region of the receiving chamber. The images are to have image properties, such as, for example, a resolution, a depth of focus, a number of gray shades or color shades, etc., which allow welding conditions which may have an impact on the quality of welds of the joining partners to be monitored on the basis of the images. For example, the camera may be designed for an image resolution of at least 64×64 pixels, preferably at least 256×256 pixels or even in the range of one or a few megapixels. For this purpose, the camera may comprise a flat image sensor such as, for example, a CCD sensor or a CMOS sensor. For specific applications, it may optionally be sufficient to equip the camera with a linear image sensor or even only with a punctiform image sensor and to scan therewith the partial region to be recorded as an image.

The partial region of the receiving chamber of which the camera assembly is to record images may be located, for example, adjacent to the sonotrode. In this case, a field of view of the camera assembly corresponding to the partial region to be recorded, within which sufficiently sharp images and/or images with sufficiently high resolution may be recorded with the camera, may correspond to a volume adjacent to a total area of a surface of the sonotrode directed toward the receiving chamber or partial volumes thereof. In particular, the partial region of the receiving chamber to be imaged is to comprise those volume portions in which the joining partners are typically received or in which, for example, boundary surfaces between the joining partners that are relevant for the quality of the welds are typically arranged.

The images recorded by the camera assembly may in the simplest case be displayed on a display. In this case, the images may be displayed as a fixed image or as a plurality of temporally successive images, for example as a video-like image sequence. Accordingly, the operator of the ultrasonic welding device no longer needs to look with difficulty into the receiving chamber but may monitor the conditions therein visually on the basis of the recorded images. Individual image sections may optionally be displayed on an enlarged scale.

Additionally or alternatively, the images, as explained in greater detail below, may also be used to implement further functionalities for the ultrasonic welding device, in particular for monitoring welding conditions therein.

According to one embodiment, the camera assembly may be arranged outside the receiving chamber and may be configured to record the images of the partial region of the receiving chamber from one side in relation to a surface of the sonotrode defining the receiving chamber.

Expressed differently, it is preferred to form the camera assembly as an integral part of the ultrasonic welding device but arrange it not within the receiving chamber defined by the sonotrode and the anvil but rather outside the receiving chamber. Accordingly, the sonotrode and the anvil may be moved relative to each other without being affected by the camera assembly.

However, in order nevertheless to be able to look into the receiving chamber and to be able to record images of the partial region within the receiving chamber, these images are to be recorded from one side, for example at an oblique angle. The angle may be chosen differently according to the application. The angle is relative to the surface of the sonotrode directed toward the receiving chamber and may be, for example, between a steep angle that is almost perpendicular (for example between 70° and 85°) via obliquely from the side (for example between 0° and 70°) to obliquely from beneath (for example between −30° and 0°). The angle could also relate to a connection direction between the sonotrode and the anvil and then be, for example, between 5° and 120°, preferably between 10° and 70°. In particular, the camera of the camera assembly, based on this connection direction, may be arranged obliquely next to the receiving chamber, i.e. offset laterally relative to the receiving chamber in a direction in which the joining partners can be pushed into the receiving chamber, in order then to be able to look obliquely into the receiving chamber. Accordingly, the camera is able to record images of the desired part of the receiving chamber without being impeded by the anvil or the sonotrode.

According to one embodiment, the ultrasonic welding device may further comprise a light source which is configured to illuminate the partial region of the receiving chamber in which the images are to be recorded by the camera assembly.

With such a light source, the partial region of the receiving chamber to be imaged, which in most cases is located far inside the ultrasonic welding device and is largely shadowed from ambient light by surrounding components, may be illuminated. As a result of the thus greatly improved lighting conditions, the quality of the images recorded by the camera assembly may be significantly increased. In addition, an influence of ambient light entering the receiving chamber, which may influence the recorded images in very different ways depending on the intensity and type of the ambient light, may be greatly reduced, so that the images may be recorded with high quality largely independently of the ambient light.

The light source may comprise one or more illuminants, for example in the form of LEDs, filament bulbs, luminescent elements or the like, wherein the use of LEDs may be preferred owing to their small overall size, low heat development and high durability.

According to a detailed embodiment, the light source may comprise a plurality of illuminants arranged in a distributed manner

For example, the light source may comprise two, three, four, five or more individual illuminants which are arranged spaced apart from each other. In this case, it may be advantageous to arrange the illuminants one behind the other along a straight or curved line, wherein the line is preferably parallel to the insertion direction in which the joining partners are pushed into the receiving chamber and in which the longitudinal direction of the elongate joining partners typically also extends. The illuminants may preferably be arranged equidistantly from each other, but they may also be arranged at varying distances from each other. In addition, the illuminants do not all need to be arranged in the same plane. Instead, the illuminants may be arranged, for example, along a curve, in particular a circular arc. In this case, each of the illuminants is preferably arranged in such a manner that a significant proportion, preferably a predominant portion, of the light emitted thereby enters the receiving chamber and in particular falls onto the partial region to be imaged.

Because the entirety of the light intensity to be radiated into the receiving chamber is generated not by a single illuminant but by a plurality of illuminants arranged in a distributed manner, it is possible, inter alia, to achieve more homogeneous illumination in the receiving chamber and thus a better quality of the recorded images.

According to one embodiment, the light source may be configured to illuminate the partial region of the receiving chamber predominantly with diffuse light.

Expressed differently, the illuminant(s) of the light source may be selected, and/or the light emission thereof may be influenced by supplementary measures, in such a manner that they do not direct light in a directed, in particular focused, manner toward the partial region of the receiving chamber to be illuminated. Instead, the light reaching the partial region should be as diffuse as possible, i.e. illuminate the partial region from different directions.

It may thereby be achieved, inter alia, that the partial region is illuminated very homogeneously, so that the quality of the recorded images may be increased. In addition, diffuse illumination makes it possible to reduce pronounced local reflections, such as could otherwise occur, for example, when the light strikes metal surfaces defining the receiving chamber.

Diffuse illumination of the receiving chamber may be achieved, for example, in that the illuminants do not illuminate the receiving chamber directly but rather a light-scattering component is interposed between the illuminants and the receiving chamber. Such a light-scattering component may consist of a transparent or semi-transparent material such that no or only a small amount of light is absorbed therein. However, scattering particles contained in the material and/or a rough texture provided at a surface of the material, for example, may result in light which has passed through the material being scattered diffusely from its original direction. The illuminants may be integrated in such a light-scattering component or may be arranged on an opposing side of such a light-scattering component, based on the receiving chamber.

According to a further detailed embodiment, the light source may be configured to selectively illuminate the partial region of the receiving chamber with light of different colors.

For this purpose, the light source may comprise, for example, one or more illuminants which may selectively be activated to emit light of different colors, i.e. are color tunable. For example, tunable LEDs may be used as illuminants. Alternatively, a plurality of illuminants may be provided in the light source, wherein each illuminant may emit light of one color and the light colors of the illuminants differ, so that the light color of the light source can be chosen by selectively switching illuminants on and off. For example, a plurality of LEDs which differ in respect of their emitted light color may be provided in the light source.

The selectability of the light color may be advantageous to the extent that, for example, some of the welding conditions to be observed can better be recognized in recorded images than other welding conditions when a different light color is used. For example, wires of strands to be welded may better be imaged with light (for example red light) whose spectrum differs from light with which, for example, materials or structures of other components arranged inside the ultrasonic welding device may advantageously be imaged.

According to one embodiment, the light source may be configured to illuminate the partial region of the receiving chamber with a light pattern.

Expressed differently, the light source may be configured not to illuminate the partial region to be imaged completely homogeneously but rather to illuminate it with a light pattern in which light striking adjacent regions differs locally in terms of its light intensity and/or its spectrum. In other words, the light pattern may have adjacent lighter and darker regions and/or adjacent regions of different colors. The differently illuminated regions of the light pattern may be very closely adjacent and have dimensions which are significantly smaller than the dimensions of the partial region to be imaged, so that the partial region is illuminated with a plurality of such light pattern regions. In particular, a number of light pattern regions may be significantly greater than a number of illuminants in the light source. The light pattern may be regular, i.e. composed of periodically repeating partial patterns. The light pattern may consist of a plurality of regions extending in parallel in lines and may thus be referred to as a striped pattern. Alternatively, the light pattern may also have other, preferably regular arrangements of light pattern regions.

The light pattern may be produced, for example, by guiding light coming from a light source through an additional optical component, for example, by which the light is absorbed locally differently and/or focused locally differently according to the light pattern. For example, the optical component used for this purpose may be arranged between the light source and the partial region to be illuminated. In this case, the optical component may have a pattern of light and dark regions or differently colored regions complementary to the light pattern to be produced. Alternatively, the optical component may locally have different regions with different layer thicknesses and/or different refractive indices corresponding to the light pattern to be produced, so that light passing through is refracted or focused in a locally varying manner and thus the light pattern is produced.

By illuminating the partial region with a light pattern, in particular spatial structures within the partial region to be imaged may be better recognizable in the recorded images, or better evaluable. For example, by illumination with a striped pattern, structures of joining partners received inside the receiving chamber may better be recognized, in particular when these structures are not arranged laterally side by side in a viewing direction of a camera but rather are located obliquely above each other. Expressed differently, illumination with the light pattern allows height contours within the observed partial region of the receiving chamber to better be recognized.

According to one embodiment, the camera system may comprise a second camera which is arranged spaced apart from the camera already mentioned, which is referred to below as the first camera, of the camera system.

Provision of a second camera in the camera system may bring various advantages. For example, in the simplest case, redundancy in the image recording may at least be achieved, so that, for example in the event of failure of one camera, images may continue to be recorded with the other camera. For practical application, however, a more important aspect in most cases is that, because the two cameras are arranged spaced apart from each other, it may further be achieved that the partial image of the receiving chamber to be imaged can be observed from different directions with the various cameras, as a result of which the welding conditions to be monitored may better be recognized. In addition, observation from different viewing angles makes it possible in a relatively simple manner for spatial structures within the partial region to be imaged to be better recognized. In particular, the images recorded by the two cameras may be evaluated stereoscopically, for example, in order to be able to recognize spatial structures similarly as in the case of a three-dimensional image.

The two cameras used in the camera system may be identical in terms of their image recording properties, in order to make it easier to evaluate the images of the two cameras and in particular to compare the images. Alternatively, it is also possible to use two cameras which are deliberately different in terms of their image recording properties, for example so that different types of welding conditions can be optically monitored in different ways.

According to one embodiment, the first and the second cameras may be arranged on opposing sides of the receiving chamber along the insertion direction in which the joining partners are to be inserted into the receiving chamber and may be configured to record images of the partial region of the receiving chamber at different oblique angles in relation to a surface of the sonotrode defining the receiving chamber.

Expressed differently, one of the cameras, when seen in the insertion direction, may be arranged obliquely in front of the receiving chamber and the other camera may be arranged obliquely behind the receiving chamber. Accordingly, the two cameras may each look into the receiving chamber and record images of the partial region to be observed at oblique angles from the front and from the rear. In this case, the cameras may be arranged within a common plane which extends parallel to the insertion direction. Alternatively, however, different cameras may also be arranged in different planes parallel to the insertion direction.

Such an arrangement of the two cameras may be advantageous in particular if the ultrasonic welding device is equipped with so-called displaceable strand end stops. A strand end stop may be understood as being a displaceable component with which an opening, through which joining partners can normally be inserted into the receiving chamber, on one side of the receiving chamber can be closed such that joining partners can be inserted into the receiving chamber only from the other side of the receiving chamber and can be aligned with their front faces abutting the strand end stop. The strand end stop thus serves to correctly position the joining partners relative to each other along their insertion direction. Advantageously, strand end stops may be provided on both opposing sides of the receiving chamber so that they can selectively define the receiving chamber and thus serve as a mechanical stop for joining partners inserted into the receiving chamber from one side or from the opposing side.

However, if the strand end stop blocks the opening to the receiving chamber on its side, a camera may no longer record images of the partial region of the receiving chamber to be observed. Accordingly, it may be advantageous to provide a second camera which is arranged on an opposing side, based on the receiving chamber, and may thus look into the receiving chamber from the opposing side without being impeded by the strand end stop.

According to a further embodiment, the camera assembly further comprises an image evaluation device which is configured to evaluate images recorded with the camera assembly in order to generate data with the aid of which the welding conditions are to be assessed.

Expressed differently, the images recorded by the camera assembly may preferably not merely be displayed unchanged on a screen, for example, in order to display them to the operator of the ultrasonic welding device but rather the images may be evaluated further in order to extract therefrom, for example, supplementary data which would not be recognizable or would be recognizable with difficulty for the operator solely by looking at the images and on the basis of which additional information about the welding conditions to be observed can be obtained.

For this purpose, the image evaluation device may perform an image analysis, for example. In the image analysis, for example, certain typical structures in images which are associated with the welding conditions may be recognized.

For example, image analysis may be used to recognize whether joining partners have been correctly positioned in the receiving chamber by, for example, recognizing edges of the joining partners and/or edges of components of the ultrasonic welding device and analyzing the positioning thereof relative to each other.

The image evaluation device may have a processor and optionally data storage, so that image data from the camera assembly may be read in, possibly stored temporarily and then processed by the processor. The image evaluation device may be controlled by software. For evaluating the images, the image evaluation device may, for example, recognize typical structures, patterns, colored regions or the like in the images and derive therefrom information about the welding conditions to be observed, for example by comparison with previously determined references.

The data obtained by evaluating the images may be used, for example, to provide an operator with additional information which may assist them in monitoring the welding conditions. Alternatively or additionally, the data obtained may also be used in the ultrasonic welding device itself, for example for suitably influencing a welding process to be performed and/or for actively influencing the positioning of joining partners. The data may optionally also be transmitted to external devices, such as a gripper system, a robot or the like, in order to render them capable of suitably actuating the ultrasonic welding device and/or, for example, suitably inserting joining partners into the receiving chamber.

According to a detailed embodiment, the image evaluation device may be configured to spatially evaluate the images recorded with the camera assembly in such a manner that data generated thereby contain information about the welding conditions which is location-dependent in three dimensions.

In other words, the image evaluation device may preferably analyze the recorded images in such a manner that not only are two-dimensional structures recognized therein and used to derive information about the welding conditions, but depth information is additionally also extracted from the recorded images, so that information about the welding conditions can be determined three-dimensionally.

For this purpose, images of the partial region of the receiving chamber may, for example, be recorded from different viewing angles with different cameras, and spatial information may then be derived from the images, for example by stereoscopic image processing. Alternatively or additionally, structures located in the partial region may be illuminated with a light pattern so that spatial information may then be derived from the correspondingly patterned images by suitable image analysis. The information about the welding conditions, which is thus location-dependent in three dimensions, may contain valuable additional information on the basis of which, for example, an operator may recognize whether intended welding conditions are actually achieved.

According to one embodiment, the camera assembly may be composed in a modular manner of a plurality of components which are replaceable as necessary.

Expressed differently, the camera assembly may be configured not as a self-contained unit which at best may be replaced as a whole. Instead, it may be advantageous to compose the camera assembly from various components in a modular manner In this case, some of the components may be used for various purposes, whereas others of the components may be adapted specifically for one purpose and are to be replaced by different components if the camera assembly is to be used for a different purpose.

For example, a mechanical mount or a housing of the camera assembly may be usable for different purposes. In contrast, the light source and in particular the illuminants thereof and/or a scattering body to be used for generating diffuse light may be optimized for a specific purpose, for example for creating specific illumination conditions in the receiving chamber. The last-mentioned components may be replaced by different components in a modular manner, for example in order to create different illumination conditions in the receiving chamber. The modular construction of the camera assembly thus allows its properties to be adapted easily to different purposes. In addition, components which are subject to high wear, for example, may easily be replaced in a modular manner

According to one embodiment, components of the ultrasonic welding device may be replaceable. In this case, each of the components may have optically recognizable features which characterize it individually. The camera assembly may be configured to recognize the optically recognizable features by evaluating the images recorded with the camera assembly and to provide information about a respective component on the basis thereof.

Expressed differently, the ultrasonic welding device itself may also be of modular construction, so that components such as, for example, its sonotrode, its anvil, its touching element, its lateral slide and/or other components may be replaced individually. Worn components, for example, may thus be replaced or components with particular properties may be replaced by components with slightly different properties in order, for example, to be able to suitably weld joining partners of different types.

However, it must thereby be ensured that suitable components are always installed in the ultrasonic welding device. For example, when exchanging components, mistakes may result in the ultrasonic welding device being incorrectly fitted with unsuitable components.

To avoid this, or make it recognizable, the components may be marked individually. In particular, components may be marked with features characterizing them, which are to be optically recognizable. For example, such characterizing features may be particular optically recognizable forms such as edges or structured surfaces on the respective component. Alternatively, markings may also be provided in the form of codes, for example a barcode or a QR code, on surfaces of the components.

In this case, the camera assembly is to recognize these features in the images recorded thereby by image analysis, for example. For example, the camera assembly may then compare the recognized features with features previously stored in a database. Then the camera assembly may determine corresponding information about the respective component characterized by these features and provide the information to an operator, for example. Alternatively, for example in the case where it can be concluded on the basis of the features recognized by the camera assembly that an incorrect component has been installed in the ultrasonic welding device, a corresponding warning message may be outputted or the ultrasonic welding device may even be deactivated.

It should be noted that possible features and advantages of embodiments of the invention are explained herein partly with reference to an ultrasonic welding device configured according to the invention and partly with reference to a manner of operating or using the same. A person skilled in the art will recognize that the features described for individual embodiments may be suitably transferred to other embodiments in an analogous manner, may be adapted and/or interchanged to arrive at further embodiments of the invention and possibly synergistic effects.

### BRIEF DESCRIPTION OF THE DRAWINGS

Advantageous embodiments of the invention are further explained below with reference to the accompanying drawings, and neither the drawings nor the explanations are to be construed as limiting the invention in any way.

FIG. 1 shows a greatly simplified lateral view of an ultrasonic welding device according to an embodiment of the present invention.

FIG. 2 shows a perspective view of a partial region of an ultrasonic welding device according to an embodiment of the present invention.

FIG. 3 shows a perspective view of a detail of an ultrasonic welding device according to an embodiment of the present invention, with a view into the camera assembly thereof.

FIG. 4 shows a plan view of the detail shown in FIG. 3.

FIG. 5 illustrates viewing ranges of cameras in a camera assembly of an ultrasonic welding device according to an embodiment of the present invention.

FIG. 6 illustrates a modular construction of a camera assembly of an ultrasonic welding device according to an embodiment of the present invention.

The figures are merely schematic and not to scale. Identical reference numerals in the various drawings denote identical features or features having the same effect.

### DETAILED DESCRIPTION

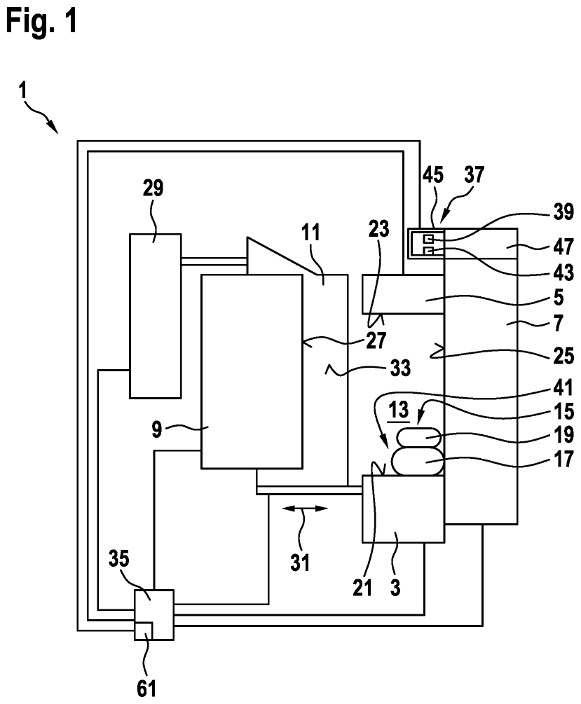

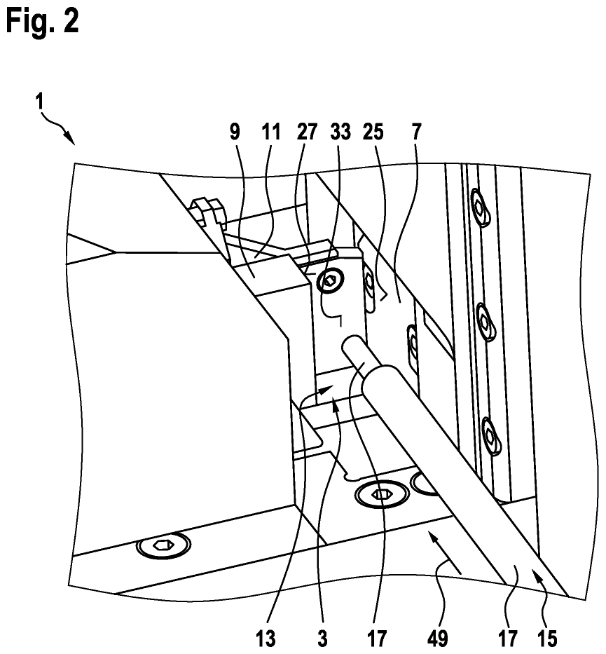

FIG. 1 shows, in a greatly simplified manner, an ultrasonic welding device 1 according to an embodiment of the present invention. FIG. 2 shows a perspective view of a receiving chamber 13 of the ultrasonic welding device 1 in a specific embodiment.

The ultrasonic welding device 1 comprises a sonotrode 3, an anvil 5, a touching element 7 and a lateral slide 9. Said components 3, 5, 7, 9 surround in a frame-like manner the receiving chamber 13 in which joining partners 15, such as a first strand 17 of a first cable and a second strand 19 of a second cable, may be received. The receiving chamber 13 is defined at the bottom by a surface 21 of the sonotrode 3, at the top by a surface 23 of the anvil 5, on the right by a surface 25 of the touching element 7 and on the left by a surface 27 of the lateral slide 9. The receiving chamber 13 defined in a frame-like manner by said surfaces 21, 23, 25, 27 is thus approximately cuboid. The receiving chamber 13 is open at the front and at the rear, so that, for example, the two strands 17, 19 can be inserted into the receiving chamber 13 from the front in an insertion direction 49.

In the example shown, the receiving chamber 13 can be defined on a rear side by a displaceable stop element 11, which may be moved by a drive device 29 in a displacement direction 31 behind the receiving chamber 13 in such a manner that the joining partners 15 can be aligned with their front faces on a surface 33 of the stop element 11 directed toward the receiving chamber 13.

Functions and/or displacements of the various activatable and/or displaceable components 3, 5, 7, 9, 11 of the ultrasonic welding device 1 may be controlled by a control system 35.

The joining partners 15 are if possible to be arranged in the receiving chamber 13 in an advantageous position relative to each other before they are welded together. However, the receiving chamber 13 is relatively small and is difficult to see into from outside, so that an operator of the ultrasonic welding device 1 must be experienced and particularly well trained in order to be able to reliably position the joining partners 15 correctly in the receiving chamber 13.

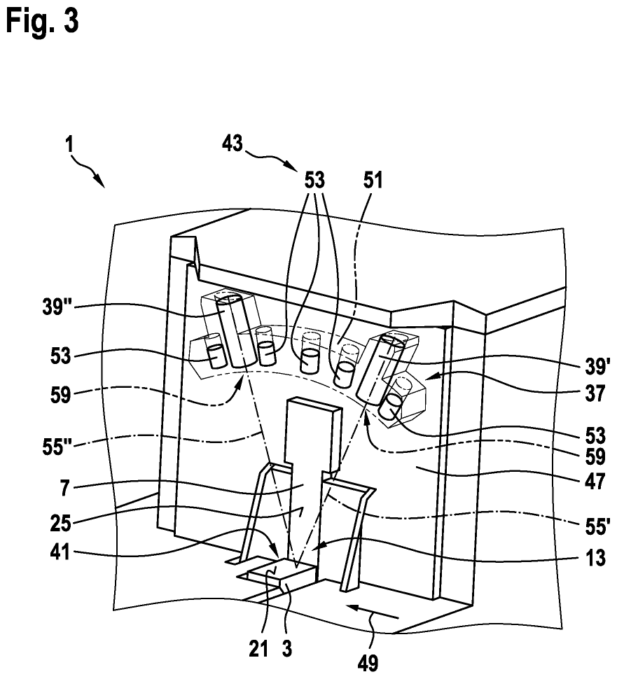

As is shown schematically in FIG. 1 and in more detail in FIG. 3-6, a camera assembly 37 is therefore provided outside the receiving chamber 13. The camera assembly 37 is designed to record images at least of a partial region 41 of the receiving chamber 13 by means of at least one camera 39. On the basis of these images, welding conditions which have an impact on the welds of the joining partners 15 that are produced during a welding process may then be monitored. In order to be able to improve the quality of and/or the information contained in these images, the camera assembly 37 may comprise a light source 43 by means of which the partial region 41 to be imaged may be illuminated. The camera assembly 37 may further be of modular construction, wherein components of the camera assembly 37 such as, for example, its camera 39, its light source 43 and possible other components are replaceably held in a housing 45, and the housing 45 is held on a fixed structure 47 of the ultrasonic welding device 1, for example. Functions of the camera assembly 37 may be controlled by the control system 35, for example.

FIG. 3-6 illustrate possible forms of the camera assembly 37 with regard to the components used therein, its geometry and its arrangement within the ultrasonic welding device 1. The housing 45 of the camera assembly 37 has not been shown in FIG. 3-5, and instead the components accommodated therein are shown.

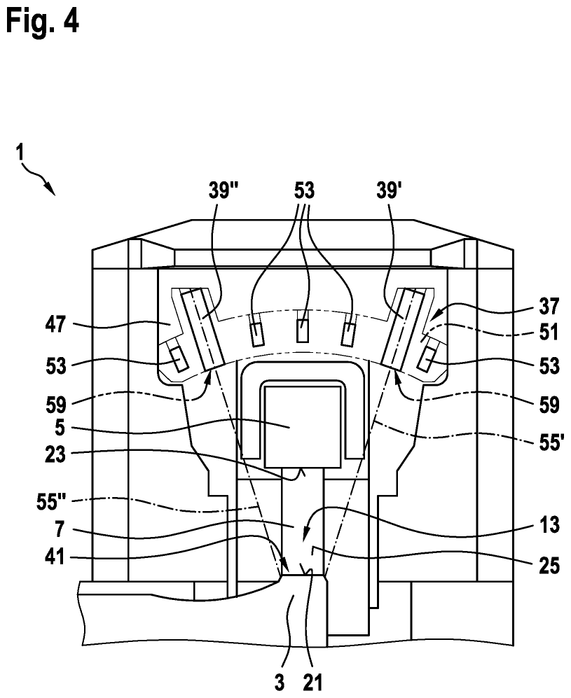

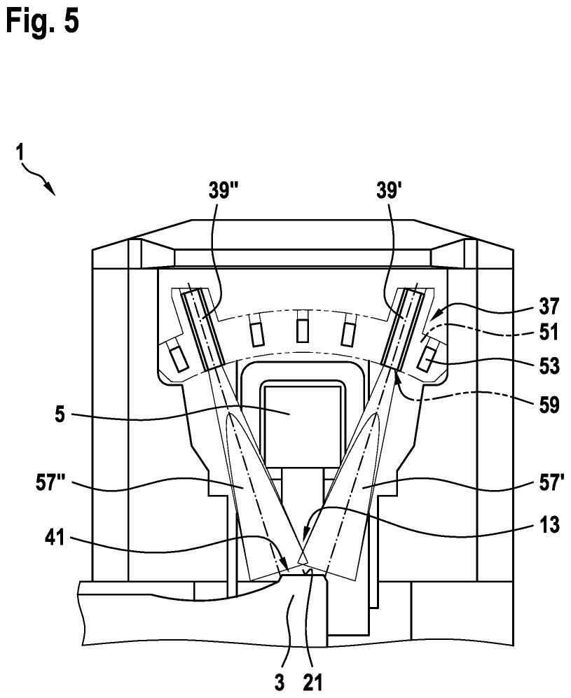

As is shown in perspective in FIG. 3 and in a plan view in FIGS. 4 and 5, the camera assembly 37 comprises an elongate, curved holding assembly 51. The elongate holding assembly 51 extends parallel to the insertion direction 49 and is arranged above the anvil 5. Two cameras 39 and a plurality of illuminants 53, which together form the light source 43, are arranged on or in the holding assembly 51. The holding assembly 51 is fastened to the fixed structure 47 of the ultrasonic welding device 1.

A front camera 39′ is arranged obliquely above and in front of the receiving chamber 13 in the insertion direction 49, whereas a rear camera 39″ is arranged obliquely above and behind the receiving chamber 13. The two cameras 39′, 39″ are oriented with their viewing axes 55′, 55″ (see FIGS. 3 and 4) obliquely toward the partial region 41 of the receiving chamber 13 to be observed, so that their conical viewing regions 57′, 57″ (see FIG. 5) at least overlap on the partial region 41 and may thus record images of joining partners 15 received therein (not shown in FIG. 3-5 for reasons of clarity) from different directions and angles.

In the example shown, the camera assembly 37 has five illuminants 53 in the form of LEDs, which are arranged on the holding assembly 51 spatially distributed in the insertion direction 49 and equidistantly one behind the other. The illuminants 53 serve to illuminate the partial region 41 to be imaged. The illuminants 53 may optionally be different in terms of the light color they emit or may be color tunable, so that the light emitted by the light source 43 may be varied in terms of color.

The holding assembly 51 preferably consists of a transparent material such as a clear plastics material. The cameras 39 may be held in the holding assembly 51 in such a manner that they are able to “see” the partial region 41 to be imaged with their viewing regions 57 through openings 59 in the holding assembly 51 and thus unhindered by the transparent material. In contrast, the illuminants 53 may be accommodated in the holding assembly 51 in such a manner that the light emitted thereby must first pass through the transparent material of the holding assembly 51 before it can then reach the partial region 41. The holding assembly 51 may be configured in such a manner that the transmitted light does not strike the partial region 41 predominantly as directed light but rather as diffuse light. For this purpose, light-scattering particles may be contained in the transparent material, for example, and/or surfaces of this material may be roughened so that they scatter light. As a result, the partial region 41 may be illuminated largely homogeneously and interfering local reflections at surrounding components of the ultrasonic welding device 1 may largely be avoided.

The holding assembly 51 or an additional optical component (not shown) to be mounted thereon, for example, may further be configured to provide the light generated by the light source 43 with a light pattern. For this purpose, regions which absorb and/or optically refract to a greater or lesser extent may be arranged adjacent to one another in the holding assembly 51 or the additional component, in order to produce lighter and darker regions and/or regions of different colors in the transmitted light. By illumination with a light pattern so produced, for example a striped pattern, structures within the partial region 41 to be imaged may better be recognized and the recorded images may optionally be evaluated in respect of their spatial arrangement.

For evaluating the images, the control system 35, for example, may comprise an image evaluation device 61. The image evaluation device may receive image data from the camera assembly 37 and generate from the recorded images, for example by image analysis, data with the aid of which the welding conditions to be observed may be assessed. In this case, the image evaluation device 61 may preferably even spatially evaluate the images in order to be able to determine information about the welding conditions location-dependently in three dimensions.

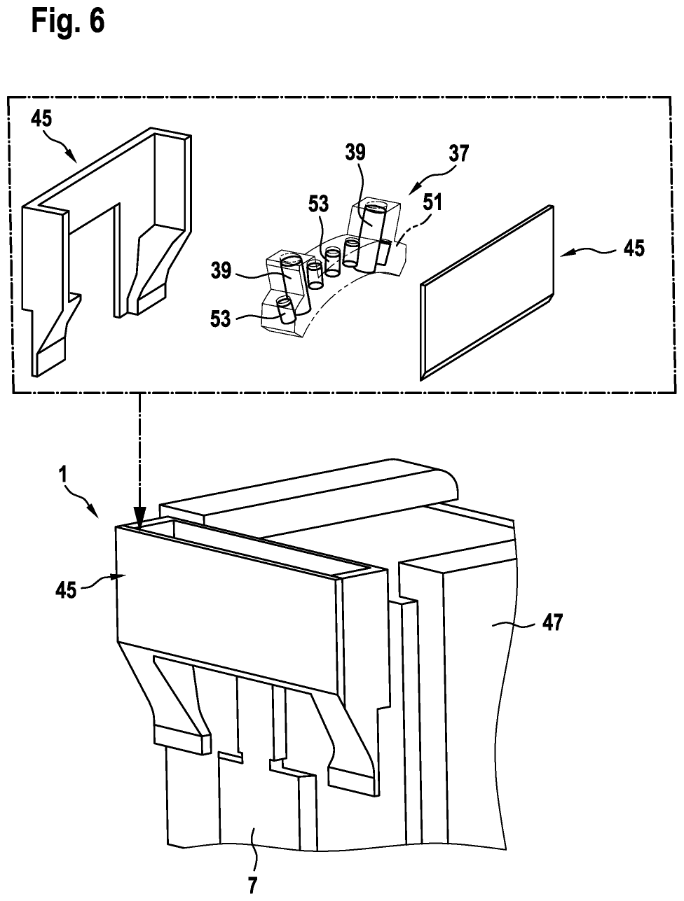

In FIG. 6, the modular construction of the camera assembly 37 is illustrated by way of example. In this case, the holding assembly 51 is accommodated inside a two-part housing 45. Thus, the holding assembly 51 and/or the cameras 39 accommodated therein as well as the illuminants 53 accommodated therein may easily be replaced in order to allow the camera assembly 37 to be adapted, for example, for modified illumination conditions.

In summary, and partially with a different wording, embodiments of the ultrasonic welding device 1 described herein may be explained as follows: By the arrangement of the cameras, which constitute an integral part of the ultrasonic welding device, the insertion process may easily be monitored and the operator may be made aware of possible insertion errors. Furthermore, in the case of closed tools (anvil pulled out and at the bottom, lateral slide pulled in), the position also allows both sides of cables serving as joining partners to be seen and to be checked for incorrect positioning, protruding wires, displacements, etc. However, owing to the limited installation space, the light conditions are very unfavorable and make reliable recognition possible only with difficulty. Moreover, the influence of ambient light is very great. However, by means of the LEDs arranged in the curve and the illuminating body acting in a curved manner as a holding assembly and the material/surface thereof, uniform illumination of the welding chamber serving as the receiving chamber is produced, whereby reliable evaluation is often only then possible. The illuminating body may be partially hollow, in order to generate light that is as diffuse as possible. As a result of the modular construction, it is also easily possible to respond to different requirements (e.g. different tools, welding position, light conditions. . . ) and to adapt the system in a simple manner For referencing, geometries (edges, radii. . . ) on the tools or additional markings are used. The geometries or markings (optionally text, barcode. . . ) may additionally be used to recognize whether the correct tools have been fitted. Wires jammed between the anvil and the lateral slide may be recognized via a gap between the two tools. By means of the arrangement of the cameras it is additionally also possible to measure the cables or the welded splices three-dimensionally. These measured values may then be used as a good/bad criterion for quality control. By means of different illuminating means (striped pattern, different colors, etc.) it is additionally possible to recognize surface forms and optionally contamination (e.g. copper deposits on the tools) and to propose necessary maintenance/cleaning to the user.

Finally, it should be noted that terms such as “having”, “comprising”, etc. do not exclude any other elements or steps and the term “one” does not exclude a plurality. It should further be pointed out that features or steps which have been described with reference to one of the above exemplary embodiments may also be used in combination with other features or steps of other exemplary embodiments described above. Reference numerals in the claims are not to be regarded as a limitation.

### LIST OF REFERENCE NUMERALS

1 Ultrasonic welding device

2 Sonotrode

5 Anvil

7 Touching element

9 Lateral slide

11 First stop element

13 Receiving chamber

15 Joining partner

17 First strand

19 Second strand

21 Surface of the sonotrode

23 Surface of the anvil

25 Surface of the touching element

27 Surface of the lateral slide

29 Drive device

31 Displacement direction of the first stop element

33 Surface of the first stop element

35 Control system

37 Camera assembly

39 Camera

41 Partial region of the receiving chamber

43 Light source

45 Housing of the camera assembly

47 Fixed structure of the ultrasonic welding device

49 Insertion direction

51 Holding assembly

53 Illuminant

55 Viewing axes of the cameras

57 Viewing regions of the cameras

59 Openings

61 Image evaluation device

1-13. (canceled)

14. An untrasonic welding device, comprising:
a sonotrode;
an anvil;
a receiving chamber in which joining partners to be welded are to be received and which is defined on opposing sides by the sonotrode on the one hand and by the anvil on the other hand;
a camera assembly with at least one camera which is integrated in the ultrasonic welding device;
wherein the camera assembly is configured to record images of at least a partial region of the receiving chamber for the optical monitoring of welding conditions which have an impact on welds of the joining partners.

15. The ultrasonic welding device according to claim 14,
wherein the camera assembly is arranged outside the receiving chamber and is configured to record the images of the partial region of the receiving chamber from one side in relation to a surface of the sonotrode defining the receiving chamber.

16. The ultrasonic welding device according to claim 14,
further comprising a light source which is configured to illuminate the partial region of the receiving chamber in which the images are to be recorded by the camera assembly.

17. The ultrasonic welding device according to claim 16,
wherein the light source comprises a plurality of illuminants arranged in a distributed manner

18. The ultrasonic welding device according to claim 16,
wherein the light source is configured to illuminate the partial region of the receiving chamber predominantly with diffuse light.

19. The ultrasonic welding device according to claim 16,
wherein the light source is configured to selectively illuminate the partial region of the receiving chamber with light of different colors.

20. The ultrasonic welding device according to claim 16,
wherein the light source is configured to illuminate the partial region of the receiving chamber with a light pattern.

21. The ultrasonic welding device according to claim 14,
wherein the camera system comprises a second camera which is arranged spaced apart from the first camera of the camera system.

22. The ultrasonic welding device according to claim 21,
wherein the first and the second cameras are arranged on opposing sides of the receiving chamber along an insertion direction in which the joining partners are to be inserted into the receiving chamber and are configured to record images of the partial region of the receiving chamber at different oblique angles in relation to a surface of the sonotrode defining the receiving chamber.

23. The ultrasonic welding device according to claim 14,
wherein the camera assembly further comprises an image evaluation device which is configured to evaluate images recorded with the camera assembly in order to generate data with the aid of which the welding conditions are to be assessed.

24. The ultrasonic welding device according to claim 23,
wherein the image evaluation device is configured to spatially evaluate the images recorded with the camera assembly in such a manner that data generated thereby contain information about the welding conditions which is location-dependent in three dimensions.

25. The ultrasonic welding device according to claim 14,
wherein the camera assembly is composed in a modular manner of a plurality of components which are replaceable as necessary.

26. The ultrasonic welding device according to claim 14,
wherein components of the ultrasonic welding device are replaceable,
wherein each of the components has optically recognizable features which characterize it individually, and
wherein the camera assembly is configured to recognize the optically recognizable features by evaluating the images recorded with the camera assembly and to provide information about a respective component on the basis thereof.
